(19) United States
(12) Patent Application Publication
(10) Pub. No.: US 2012/0243922 A1
(43) Pub. Date: Sep. 27, 2012

(54) FIXING DEVICE AND IMAGE FORMING APPARATUS

(75) Inventors: Yasuhiro UEHARA, Kanagawa (JP); Satoshi HASEBE, Kanagawa (JP)

(73) Assignee: FUJI XEROX CO., LTD., Tokyo (JP)

(21) Appl. No.: 13/251,805

(22) Filed: Oct. 3, 2011

(30) Foreign Application Priority Data
Mar. 25, 2011 (JP) 2011-067504

(51) Int. Cl. G03G 15/20

(52) U.S. Cl. 399/329; 399/333

(57) ABSTRACT

A fixing device includes a rotatable fixing member that fixes a toner image on a recording material, and a rotatable pressure applying member that is pressed against an outer peripheral surface of the fixing member and forms a press-fixing part therebetween through which the recording material having an unfixed toner image is transported. At least one of the fixing member and the pressure applying member includes a core portion provided at a center of rotation, a compressible elastic layer provided over an outer periphery of the core portion, and a shape retaining layer provided over an outer periphery of the elastic layer and retaining a shape of the at least one of the fixing member and the pressure applying member.

### CROSS-REFERENCE TO RELATED APPLICATIONS

This application is based on and claims priority under 35 USC 119 from Japanese Patent Application No. 2011-067504 filed Mar. 25, 2011.

### BACKGROUND

(i) Technical Field

The present invention relates to a fixing device and an image forming apparatus.

(ii) Related Art

An electrophotographic image forming apparatus such as a copier or a printer forms an electrostatic latent image on a photoconductor having, for example, a drum-like shape by uniformly charging the photoconductor and exposing the charged photoconductor to light controlled on the basis of image information. The electrostatic latent image is developed with toner into a visible image (toner image). The toner image is transferred to a recording material. The transferred toner image is fixed by a fixing device. Thus, an image is formed.

### SUMMARY

According to an aspect of the invention, there is provided a fixing device including a rotatable fixing member that fixes a toner image on a recording material, and a rotatable pressure applying member that is pressed against an outer peripheral surface of the fixing member and forms a press-fixing part therebetween through which the recording material having an unfixed toner image is transported. At least one of the fixing member and the pressure applying member includes a core portion provided at a center of rotation, a compressible elastic layer provided over an outer periphery of the core portion, and a shape retaining layer provided over an outer periphery of the elastic layer and retaining a shape of the at least one of the fixing member and the pressure applying member.

### BRIEF DESCRIPTION OF THE DRAWINGS

An exemplary embodiment of the present invention will be described in detail based on the following figures, wherein:

FIG. 1 illustrates an exemplary image forming apparatus to which a fixing device according to the exemplary embodiment is applied;

FIG. 2 is a front view of the fixing device according to the exemplary embodiment;

FIG. 3 is a sectional view of the fixing device taken along line III-III illustrated in FIG. 2;

FIG. 4 is a sectional view illustrating layers included in a fixing belt according to the exemplary embodiment;

FIG. 5 is a sectional view of an induction-heating (IH) heater according to the exemplary embodiment;

FIG. 6 illustrates lines of magnetic force produced when the fixing belt is at or below a temperature at which magnetic permeability starts to change;

FIG. 7 illustrates a pressure applying roller having been moved away from the fixing belt by a movement mechanism;

FIG. 8 illustrates the relationship between the outside diameter of the pressure applying roller and Expression (3); and

FIGS. 9A to 9C each illustrate the relationship between the axial-direction position of the pressure applying roller and the amount of change in the radius of the pressure applying roller.

### DETAILED DESCRIPTION

An exemplary embodiment of the present invention will now be described in detail with reference to the accompanying drawings.

### Image Forming Apparatus

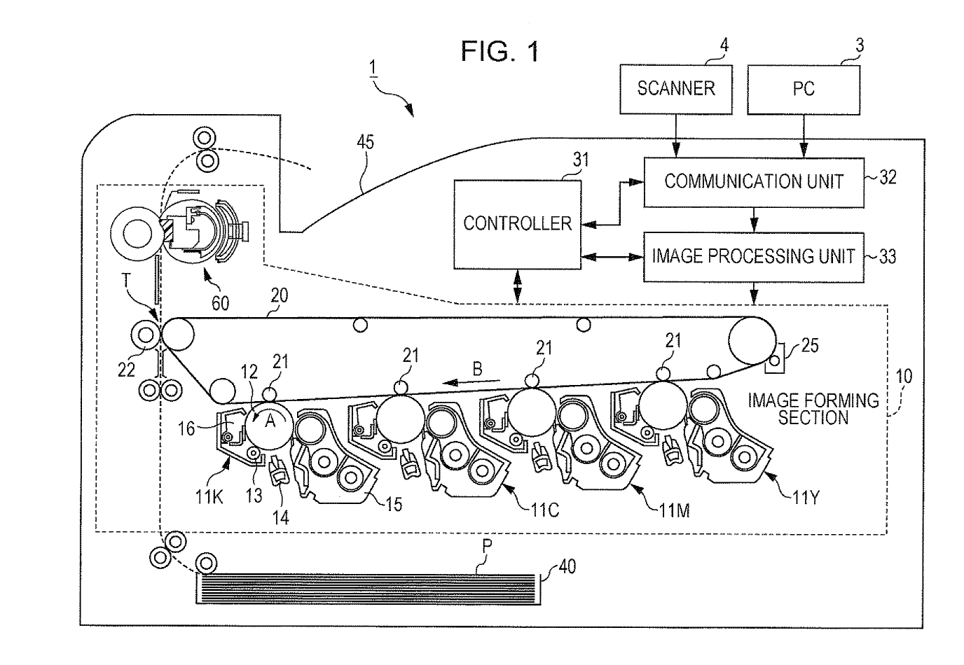

FIG. 1 illustrates an exemplary image forming apparatus 1 to which a fixing device according to the exemplary embodiment is applied. The image forming apparatus 1 illustrated in FIG. 1 is a tandem color printer and includes an image forming section 10 that forms an image on the basis of image data, a controller 31 that controls the overall operation of the image forming apparatus 1, a communication unit 32 that communicates with, for example, a personal computer (PC) 3 or an image reading device (scanner) 4 and receives the image data, and an image processing unit 33 that performs a predetermined image processing operation on the image data received by the communication unit 32.

The image forming section 10 is an exemplary toner-image-forming section that forms a toner image. The image forming section 10 includes four image forming units 11Y, 11M, 11C, and 11K (also generally referred to as “image forming units 11”) that are provided side by side at predetermined intervals. The image forming units 11 each include a photoconductor drum 12 as an exemplary image carrier on which an electrostatic latent image is formed and that carries a toner image, a charging device 13 that uniformly charges the surface of the photoconductor drum 12 with a predetermined potential, a light-emitting-diode (LED) printhead 14 that performs, on the basis of image data for a corresponding one of different colors, exposure on the photoconductor drum 12 charged by the charging device 13, a developing device 15 that develops the electrostatic latent image formed on the photoconductor drum 12, and a drum cleaner 16 that cleans the surface of the photoconductor drum 12 after transfer. The image forming units 11 all have substantially the same configuration except the colors of toners contained in the developing devices 15. The image forming units 11 form toner images in different colors of yellow (Y), magenta (M), cyan (C), and black (K), respectively.

The image forming section 10 also includes an intermediate transfer belt 20 to which the toner images in different colors formed on the photoconductor drums 12 of the respective image forming units 11 are multiply transferred, first transfer rollers 21 with which the toner images in different colors formed by the respective image forming units 11 are sequentially transferred (first-transferred) to the intermediate transfer belt 20 in such a manner as to be superposed one on top of another, a second transfer roller 22 with which the toner images in different colors superposed on the intermediate transfer belt 20 are transferred at a time (second-transferred) to paper P, i.e., a recording material (recording paper), and a fixing unit 60 as an exemplary fixing section (fixing device) that fixes the second-transferred toner images in different colors on the paper P. In the image forming apparatus 1 according to the exemplary embodiment, the intermediate transfer belt 20, the first transfer rollers 21, and the second transfer roller 22 in combination form a transfer section that transfers the toner images to the paper P.

The image forming apparatus 1 according to the exemplary embodiment performs an image forming operation in the following process under the control of the controller 31. Specifically, image data from the PC 3 or the scanner 4 is received by the communication unit 32 and is subjected to the predetermined image processing operation performed by the image processing unit 33, thereby being converted into pieces of image data for the different colors. The pieces of image data are transmitted to the respective image forming units 11. For example, in the image forming unit 11K that forms a black (K)-colored toner image, the photoconductor drum 12 rotating in the direction of arrow A is uniformly charged with the predetermined potential by the charging device 13, and the LED printhead 14 performs scan exposure on the photoconductor drum 12 on the basis of the piece of image data for the K color transmitted from the image processing unit 33. Thus, an electrostatic latent image for the K color is formed on the photoconductor drum 12. The electrostatic latent image for the K color on the photoconductor drum 12 is developed by the developing device 15, whereby a K-colored toner image is formed on the photoconductor drum 12. Likewise, yellow (Y)-colored, magenta (M)-colored, and cyan (C)-colored toner images are formed by the other image forming units 11Y, 11M, and 11C, respectively.

The different-colored toner images thus formed on the photoconductor drums 12 of the respective image forming units 11 are sequentially electrostatically transferred (first-transferred) to the intermediate transfer belt 20 rotating in the direction of arrow B by the respective first transfer rollers 21, whereby superposed toner images in which the different-colored toners are superposed are formed. The superposed toner images on the intermediate transfer belt 20 are transported, with the rotation of the intermediate transfer belt 20, to an area (second transfer part T) where the second transfer roller 22 is provided. When the superposed toner images reach the second transfer part T, paper P fed from a paper holder 40 is transported to the second transfer part T. Subsequently, at the second transfer part T, the superposed toner images are electrostatically transferred at a time (second-transferred) to the thus transported paper P by an effect of a transfer electric field produced by the second transfer roller 22.

Subsequently, the paper P having the superposed toner images electrostatically transferred thereto is transported to the fixing unit 60. The superposed toner images on the paper P transported to the fixing unit 60 are subjected to heat and pressure applied by the fixing unit 60 and are thus fixed on the paper P. The paper P having the thus fixed image is transported to a paper stacking part 45 in a paper output portion of the image forming apparatus 1.

Meanwhile, toners adhering to the photoconductor drums 12 after the first transfer (first-transfer residual toner) and toners adhering to the intermediate transfer belt 20 after the second transfer (second-transfer residual toner) are removed by the drum cleaners 16 and a belt cleaner 25, respectively.

The image forming apparatus 1 repeats the above image forming process for the number of pages to be printed.

### Fixing Unit

The fixing unit 60 according to the exemplary embodiment will now be described.

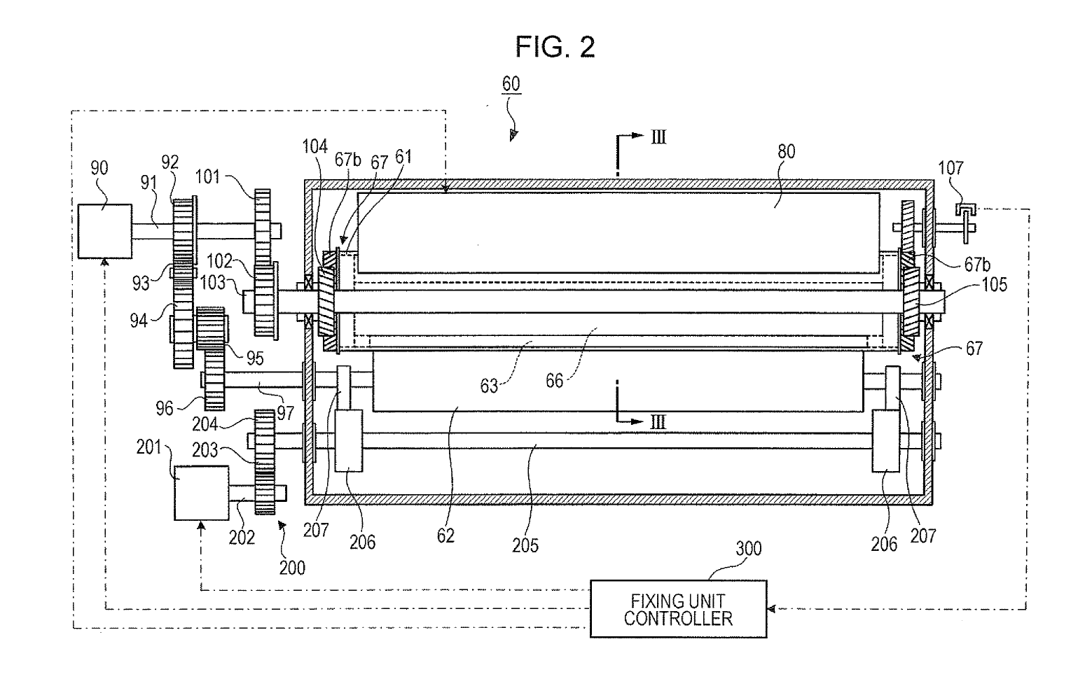

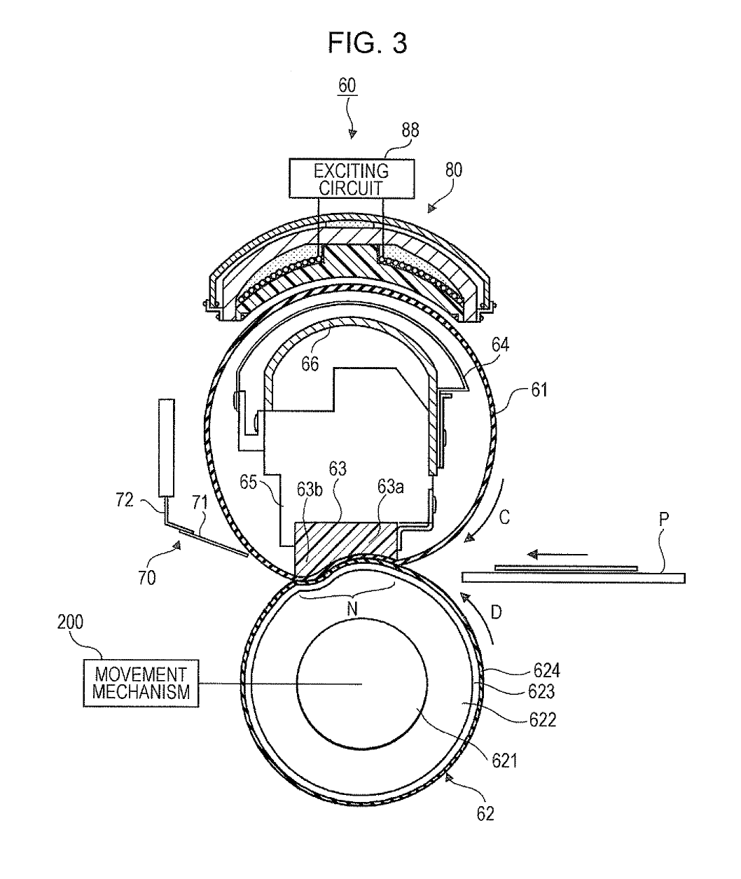

FIGS. 2 and 3 illustrate the fixing unit 60 according to the exemplary embodiment. FIG. 2 is a front view. FIG. 3 is a sectional view taken along line III-III illustrated in FIG. 2.

Referring to the sectional view of FIG. 3, the fixing unit 60 includes an induction-heating (IH) heater 80 that produces an alternating-current magnetic field, a fixing belt 61 as an exemplary fixing member that is heated by electromagnetic induction caused by the IH heater 80 and thus fixes toner images on paper P, a pressure applying roller 62 as an exemplary pressure applying member that faces the fixing belt 61, and a pressure receiving pad 63 against which the pressure applying roller 62 is pressed with the fixing belt 61 interposed therebetween. When the pressure applying roller 62 is pressed against the outer peripheral surface of the fixing belt 61, a nip part N (press-fixing part) through which paper P having unfixed toner images is transported is formed between the pressure applying roller 62 and the fixing belt 61.

Furthermore, the fixing unit 60 includes a holder 65 that supports the pressure receiving pad 63 and other elements, a temperature-sensitive magnetic member 64 that produces a magnetic circuit by inducing thereinto the alternating-current magnetic field produced by the IH heater 80, an induction member 66 that induces thereinto lines of magnetic force that have passed through the temperature-sensitive magnetic member 64, and a release assisting member 70 that assists releasing of the paper P from the fixing belt 61.

### Fixing Belt

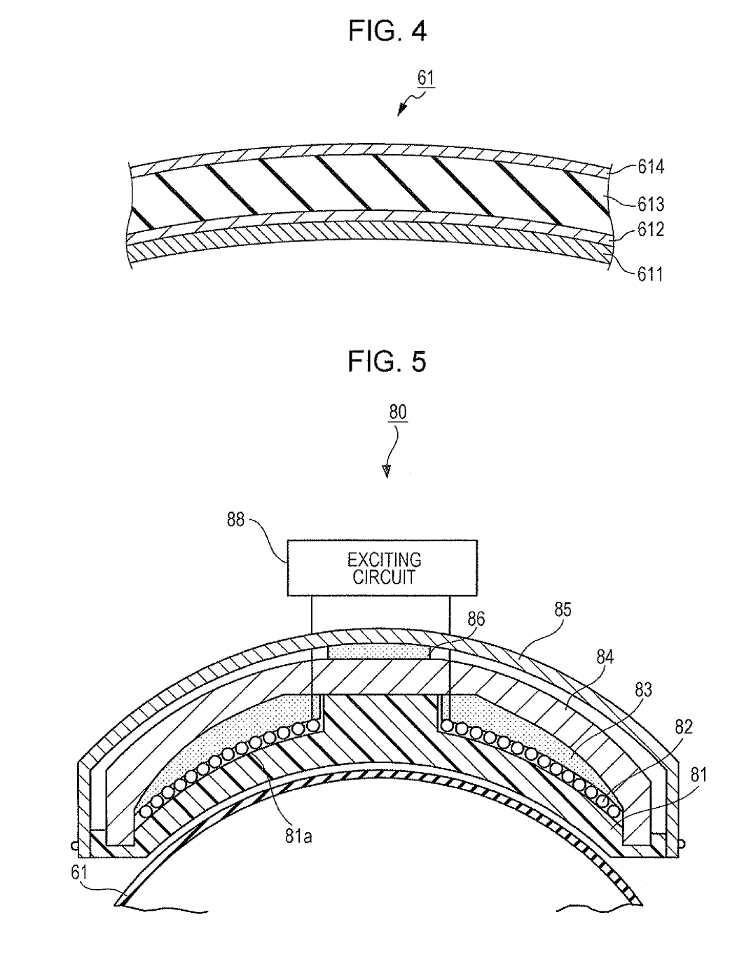

The fixing belt 61 is an endless belt member that originally has a round cylindrical shape with, for example, a diameter of 30 mm in its original shape (round cylindrical shape) and a length of 370 mm. Referring to FIG. 4 (a sectional view illustrating layers included in the fixing belt 61), the fixing belt 61 is a multilayer belt member including a base layer 611, a conductive heating layer 612 overlying the base layer 611, an elastic layer 613 improving the capability of fixing toner images, and a surficial release layer 614 provided as the outermost layer.

The base layer 611 supports the conductive heating layer 612, which has a small thickness, and is a heat-resistive sheet-like member that provides good mechanical strength to the fixing belt 61 as a whole. The base layer 611 is made of a material having a thickness and physical properties (relative permeability and resistivity) that allow the alternating-current magnetic field produced by the IH heater 80 to pass therethrough and to act on the temperature-sensitive magnetic member 64. The base layer 611 itself, however, does not generate heat or hardly generates heat with the effect of the magnetic field.

Specifically, for example, the base layer 611 has a thickness of 30 μm to 200 μm (preferably, 50 μm to 150 μm) and is made of non-magnetic metal such as non-magnetic stainless steel, a resin material having a thickness of 60 μm to 200 μm, or the like.

The conductive heating layer 612 is an exemplary conductive layer and is an electromagnetic-induction heating layer that is heated by electromagnetic induction caused by the alternating-current magnetic field produced by the IH heater 80. That is, an eddy current occurs in the conductive heating layer 612 when the alternating-current magnetic field produced by the IH heater 80 passes through the conductive heating layer 612 in the thickness direction.

Usually, a general-purpose power supply manufacturable at a low cost is used as the power source for an exciting circuit 88 (see FIG. 5) that supplies an alternating current to the IH heater 80. Therefore, the frequency of the alternating-current magnetic field produced by the IH heater 80 usually ranges from 20 kHz to 100 kHz, corresponding to the frequency of the general-purpose power supply. Hence, the conductive heating layer 612 is configured to allow an alternating-current magnetic field at a frequency of 20 kHz to 100 kHz to enter and pass therethrough.

The alternating-current magnetic field is allowed to enter a region of the conductive heating layer 612 where the alternating-current magnetic field is attenuated to 1/e. The region is defined by “skin depth (δ)”, which is obtained from Expression (1) below.

$$δ = 503 \sqrt{\frac{ρ}{f \cdot {μ}_{r}}} \qquad ( 1 )$$

where f denotes the frequency of the alternating-current magnetic field (20 kHz, for example), ρ denotes the resistivity (Ω·m), and μ denotes the relative permeability.

Hence, the conductive heating layer 612 is thinner than the skin depth (δ) of the conductive heating layer 612 defined by Expression (1) so that an alternating-current magnetic field at a frequency of 20 kHz to 100 kHz is allowed to enter and pass through the conductive heating layer 612. Exemplary materials for the conductive heating layer 612 include metals such as Au, Ag, Al, Cu, Zn, Sn, Pb, Bi, Be, and Sb, and alloys of any of the foregoing metals.

Specifically, for example, the conductive heating layer 612 has a thickness of 2 μm to 20 μm and a resistivity of 2.7×10⁻⁸ Ω·m or smaller and is made of non-magnetic metal such as Cu (non-magnetic material having a relative permeability of about 1).

The conductive heating layer 612 may have such a small thickness in terms of reducing the time required for heating the fixing belt 61 to a preset fixing temperature (hereinafter referred to as “warm-up time”).

The elastic layer 613 is made of a heat-resistive elastic material such as silicone rubber. Toner images on the paper P, i.e., the object of fixing, are layers of powder toners having different colors. Therefore, to heat the entirety of the toner images very uniformly at the nip part N, the surface of the fixing belt 61 may be deformable along a rugged surface formed by the toner images on the paper P. In such a case, silicone rubber having, for example, a thickness of 100 μm to 600 μm and a hardness of 10° to 30° (JIS-A) is suitable for the elastic layer 613.

The surficial release layer 614 directly comes into contact with unfixed toner images on the paper P and is therefore made of a material having a high releasability. Examples of such a material include a tetrafluoroethylene-perfluoroalkyl vinyl ether copolymer (PFA), polytetrafluoroethylene (PTFE), a silicone copolymer, and a composite of the foregoing materials. If the surficial release layer 614 is too thin, abrasion resistance is insufficient and the life of the fixing belt 61 is shortened. In contrast, if the surficial release layer 614 is too thick, the heat capacity of the fixing belt 61 is too large and the warm-up time is increased. Considering the balance between abrasion resistance and heat capacity, the thickness of the surficial release layer 614 may be 1 μm to 50 μm.

### Pressure Receiving Pad

The pressure receiving pad 63 is made of an elastic material such as silicone rubber or fluoro rubber and is supported by the holder 65 at a position facing the pressure applying roller 62. In a state where the pressure receiving pad 63 is pressed by the pressure applying roller 62 with the fixing belt 61 interposed therebetween, the nip part N (press-fixing part) is formed between the pressure receiving pad 63 and the pressure applying roller 62.

The pressure receiving pad 63 includes a pre-nip region 63a on an entrance side of the nip part N (the upstream side in the direction of transport of the paper P) and a releasing nip region 63b on an exit side of the nip part N (the downstream side in the direction of transport of the paper P). The pre-nip region 63a and the releasing nip region 63b receive different nip pressures. Specifically, a surface of the pre-nip region 63a nearer to the pressure applying roller 62 extends in an arc shape substantially along the outer peripheral surface of the pressure applying roller 62 and receives a relatively uniform nip pressure over a wide area of the nip part N. The releasing nip region 63b has such a shape that a portion of the fixing belt 61 running therealong has a small radius of curvature. Furthermore, the releasing nip region 63b receives a large nip pressure locally applied thereto from the surface of the pressure applying roller 62. Thus, a curl in a direction away from the surface of the fixing belt 61 (a down curl) is formed in the paper P running along the releasing nip region 63b, whereby releasing of the paper P from the surface of the fixing belt 61 is facilitated.

In the exemplary embodiment, the release assisting member 70 as an assist member that assists releasing of the paper P by the pressure receiving pad 63 is provided on the downstream side with respect to the nip part N. The release assisting member 70 includes a release baffle 71 and a holder 72 that supports the release baffle 71. The release baffle 71 is oriented in a direction (counter direction) opposite to the direction of rotation of the fixing belt 61 and extends to a position close to the fixing belt 61. The release baffle 71 supports the curl formed in the paper P at the exit of the pressure receiving pad 63, thereby preventing the paper P from advancing along the fixing belt 61.

### Temperature-Sensitive Magnetic Member

The temperature-sensitive magnetic member 64 has an arc shape extending along the inner peripheral surface of the fixing belt 61. The temperature-sensitive magnetic member 64 is positioned close to, but is not in contact with, the inner peripheral surface of the fixing belt 61 with a predetermined gap (0.5 mm to 1.5 mm, for example) interposed therebetween. The temperature-sensitive magnetic member 64 is positioned closed to the fixing belt 61 so that the temperature of the temperature-sensitive magnetic member 64 changes with the temperature of the fixing belt 61, that is, the temperature of the temperature-sensitive magnetic member 64 becomes substantially the same as the temperature of the fixing belt 61. The temperature-sensitive magnetic member 64 is not in contact with the fixing belt 61 so that the heat of the fixing belt 61 is prevented from being absorbed into the temperature-sensitive magnetic member 64 before the fixing belt 61 is heated to the preset fixing temperature after the power of the image forming apparatus 1 is turned on. Thus, the warm-up time is reduced.

The temperature-sensitive magnetic member 64 is made of such a material that the temperature at which the magnetic permeability, one of magnetic properties, of the material suddenly changes (described separately below) is at or above the preset fixing temperature, at which toner images in different colors melt, and below the heat resistant temperatures of the elastic layer 613 and the surficial release layer 614 of the fixing belt 61. In other words, the temperature-sensitive magnetic member 64 is made of a material exhibiting “temperature-sensitive magnetism”, that is, the temperature-sensitive magnetic member 64 changes reversibly between exhibiting ferromagnetism and non-magnetism (paramagnetism) in a temperature range including the preset fixing temperature. At or below the temperature at which magnetic permeability starts to change, the temperature-sensitive magnetic member 64 is ferromagnetic and functions as a magnetic-circuit-producing member that induces thereinto lines of magnetic force produced by the IH heater 80 and intersecting the fixing belt 61, thereby producing an alternating-current magnetic circuit (lines of magnetic force), part of which runs through the temperature-sensitive magnetic member 64. Thus, the temperature-sensitive magnetic member 64 produces a closed magnetic circuit enclosing the fixing belt 61 and an exciting coil 82 (see FIG. 5) of the IH heater 80. In contrast, above the temperature at which magnetic permeability starts to change, the temperature-sensitive magnetic member 64 allows the lines of magnetic force produced by the IH heater 80 and intersecting the fixing belt 61 to pass therethrough in the thickness direction. Thus, the lines of magnetic force produced by the IH heater 80 and intersecting the fixing belt 61 form a magnetic circuit intersecting the temperature-sensitive magnetic member 64, running through the induction member 66, and returning to the IR heater 80.

The “temperature at which magnetic permeability starts to change” refers to a temperature at which magnetic permeability (measured in accordance with JIS C2531, for example) starts to drop continuously, specifically, a temperature at which the amount of magnetic flux (the number of lines of magnetic force) permeating through the temperature-sensitive magnetic member 64 and other elements starts to change. That is, the temperature at which magnetic permeability starts to change is close to the Curie point, at which materials lose their magnetism, but is based on a concept different from the Curie point.

The temperature-sensitive magnetic member 64 is made of such a material that the temperature at which magnetic permeability starts to change is set so as to be within the range of, for example, 140° C. (the preset fixing temperature) to 240° C. Examples of such a material include binary temperature-sensitive magnetic alloys such as an Fe—Ni alloy (permalloy) and ternary temperature-sensitive magnetic alloys such as an Fe—Ni—Cr alloy. In the case of an Fe—Ni binary temperature-sensitive magnetic alloy, the temperature at which magnetic permeability starts to change may be set to about 225° C. in a proportion (atomic ratio) of about 64% for Fe to about 36% for Ni. Metal alloys such as permalloys and temperature-sensitive magnetic alloys are easy to mold and easy to machine, have high heat conductivity, and are inexpensive. Therefore, such metal alloys are suitable for the temperature-sensitive magnetic member 64. Exemplary components of such metal alloys include Fe, Ni, Si, B, Nb, Cu, Zr, Co, Cr, V, Mn, and Mo.

The temperature-sensitive magnetic member 64 is made thicker than the skin depth δ (see Expression (1) above) that allows entry of the alternating-current magnetic field (lines of magnetic force) produced by the IH heater 80. For example, in the case of an Fe—Ni alloy, the thickness of the temperature-sensitive magnetic member 64 is set to about 50 μm to about 300 μm.

### Holder

The holder 65 supporting the pressure receiving pad 63 is made of a highly rigid material so that the amount of bend thereof occurring when a pressing force is applied thereto by the pressure applying roller 62 becomes smaller than a predetermined amount. Thus, the pressure at the nip part N (nip pressure) is maintained to be uniform in the longitudinal direction. The fixing unit 60 according to the exemplary embodiment employs a configuration in which the fixing belt 61 is heated by utilizing electromagnetic induction. Accordingly, the holder 65 is made of a material that does not affect or hardly affects the induction field and is not affected or is hardly affected by the induction field. Examples of such a material include heat-resistive resins such as glass-filled polyphenylene sulfide (PPS), and non-magnetic metals such as Al, Cu, and Ag.

### Induction Member

The induction member 66 has an arc shape extending along the inner peripheral surface of the temperature-sensitive magnetic member 64. The induction member 66 is not in contact with the inner peripheral surface of the temperature-sensitive magnetic member 64 with a predetermined gap (1.0 mm to 5.0 mm, for example) interposed therebetween. The induction member 66 is made of non-magnetic metal, such as Ag, Cu, or Al, having relatively small resistivity. When the temperature-sensitive magnetic member 64 is heated to a temperature above the temperature at which magnetic permeability starts to change, the induction member 66 induces thereinto the alternating-current magnetic field (lines of magnetic forces) produced by the IH heater 80, thereby falling into a state where an eddy current I occurs more easily than in the conductive heating layer 612 of the fixing belt 61. Hence, the induction member 66 has a predetermined thickness (1.0 mm, for example) much larger than the skin depth δ (see Expression (1) above) so as to allow the eddy current I to easily flow therethrough.

### IH Heater

The IH heater 80 will now be described. The IH heater 80 performs electromagnetic induction heating by producing an alternating-current magnetic field acting on the conductive heating layer 612 of the fixing belt 61.

FIG. 5 is a sectional view of the IH heater 80 according to the exemplary embodiment. As illustrated in FIG. 5, the IH heater 80 includes a support 81 made of a non-magnetic material such as heat-resistive resin, the exciting coil 82 producing an alternating-current magnetic field, an elastic support member 83 made of an elastic material and securing the exciting coil 82 on the support 81, a magnetic core 84 producing a circuit of the alternating-current magnetic field produced by the exciting coil 82, a shield 85 shielding the magnetic field, a pressing member 86 pressing the magnetic core 84 toward the support 81, and the exciting circuit 88 supplying an alternating current to the exciting coil 82.

The support 81 has a curved sectional shape extending along the surface of the fixing belt 61 and is positioned such that an upper surface (supporting surface) 81a thereof supporting the exciting coil 82 is retained at a predetermined distance (0.5 mm to 2 mm, for example) from the surface of the fixing belt 61. The support 81 is made of a heat-resistive non-magnetic material: for example, heat-resistive glass; heat-resistive resin such as polycarbonate, polyether sulfone, or PPS; or a material obtained by adding glass fibers to the foregoing heat-resistive resin.

The exciting coil 82 is produced by coiling a Litz wire into a hollow closed loop having any shape such as an oblong circular shape, an elliptic shape, or a rectangular shape. The Litz wire is a bundle of, for example, 90 copper wires insulated from one another and each having a diameter of for example, 0.17 mm. When an alternating current at a predetermined frequency is supplied from the exciting circuit 88 to the exciting coil 82, an alternating-current magnetic field centered on the Litz wire coiled into the closed loop is produced around the exciting coil 82. The frequency of the alternating current supplied from the exciting circuit 88 to the exciting coil 82 usually ranges from 20 kHz to 100 kHz, corresponding to the frequency of the alternating current generated by the above-mentioned general-purpose power supply.

The magnetic core 84 is a ferromagnetic body composed of an acid compound or an alloy having high magnetic permeability such as soft ferrite, ferrite resin, an amorphous alloy, a permalloy, or a temperature-sensitive magnetic alloy. The magnetic core 84 functions as a magnetic-circuit-producing member and induces thereinto lines of magnetic force (magnetic flux) of the alternating-current magnetic field produced by the exciting coil 82 and produces a path of the lines of magnetic force (magnetic circuit) running from the magnetic core 84, intersecting the fixing belt 61 toward the temperature-sensitive magnetic member 64, running through the temperature-sensitive magnetic member 64, and returning to the magnetic core 84. That is, the alternating-current magnetic field produced by the exciting coil 82 runs through the magnetic core 84 and the temperature-sensitive magnetic member 64, producing a closed magnetic circuit with lines of magnetic force enclosing the fixing belt 61 and the exciting coil 82. Thus, the lines of magnetic force of the alternating-current magnetic field produced by the exciting coil 82 concentrate in a portion of the fixing belt 61 that faces the magnetic core 84.

The magnetic core 84 may be made of a material that causes a small loss in production of the magnetic circuit. Specifically, the magnetic core 84 may be used in a form that reduces the eddy current loss (for example, a configuration in which the current path is cut off or divided with slits or the like, or a configuration including thin plates tied to one another) and may be made of a material causing a small hysteresis loss.

The length of the magnetic core 84 in the direction of rotation of the fixing belt 61 is smaller than the length of the temperature-sensitive magnetic member 64 in the direction of rotation of the fixing belt 61. Thus, leakage of lines of magnetic force around the IH heater 80 is reduced, and the power factor is increased. Moreover, electromagnetic induction into metal members included in the fixing unit 60 is suppressed, and the efficiency in heating the fixing belt 61 (the conductive heating layer 612) is increased.

State where Fixing Belt Generates Heat

A state where the fixing belt 61 generates heat with the alternating-current magnetic field produced by the IH heater 80 will now be described.

As described above, the temperature of the temperature-sensitive magnetic member 64 at which magnetic permeability starts to change is set so as to be at or above the preset fixing temperature at which toner images in different colors are fixed and at or below the heat resistant temperature of the fixing belt 61, i.e., within the range of 140° C. to 240° C., for example. When the fixing belt 61 is at or below the temperature at which magnetic permeability starts to change, the temperature-sensitive magnetic member 64 provided close to the fixing belt 61 is also at or below the temperature at which magnetic permeability starts to change, correspondingly to the fixing belt 61. In this state, the temperature-sensitive magnetic member 64 is ferromagnetic, and there is produced a magnetic circuit in which lines of magnetic force H of the alternating-current magnetic field produced by the IH heater 80 intersect the fixing belt 61 and run through the temperature-sensitive magnetic member 64 in a spreading direction. Here, the term “spreading direction” refers to a direction orthogonal to the thickness direction of the temperature-sensitive magnetic member 64.

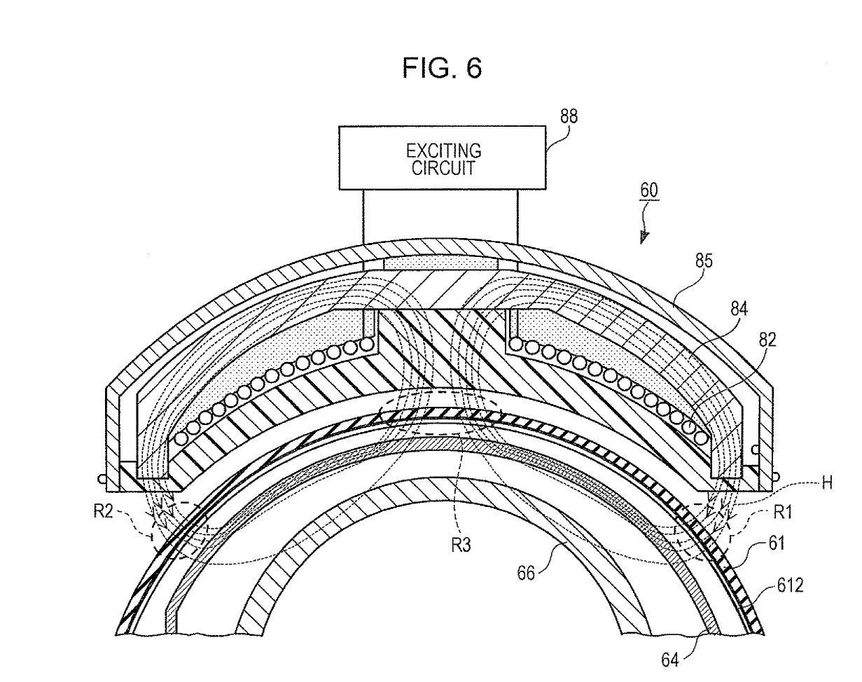

FIG. 6 illustrates lines of magnetic force (H) when the fixing belt 61 is at or below the temperature at which magnetic permeability starts to change. As illustrated in FIG. 6, when the fixing belt 61 is at or below the temperature at which magnetic permeability starts to change, the lines of magnetic force H of the alternating-current magnetic field produced by the IH heater 80 form a magnetic circuit intersecting the fixing belt 61 and running through the temperature-sensitive magnetic member 64 in the spreading direction (the direction orthogonal to the thickness direction). Therefore, the number of lines of magnetic force H per unit area (magnetic flux density) in each region of the fixing belt 61 where the lines of magnetic force H intersect the conductive heating layer 612 is large.

Specifically, after the lines of magnetic force H radiated from the magnetic core 84 of the IH heater 80 pass through the conductive heating layer 612 of the fixing belt 61 in regions R1 and R2, the lines of magnetic force H are induced into the temperature-sensitive magnetic member 64 that is ferromagnetic. Therefore, the lines of magnetic force H intersecting the conductive heating layer 612 of the fixing belt 61 in the thickness direction concentrate in such a manner as to enter the temperature-sensitive magnetic member 64. Accordingly, the magnetic flux density is high in the regions R1 and R2. Furthermore, when the lines of magnetic force H that have run through the temperature-sensitive magnetic member 64 in the spreading direction return to the magnetic core 84 through a region R3 where the lines of magnetic force H intersect the conductive heating layer 612 in the thickness direction, the lines of magnetic force H are concentratedly radiated from portions of the temperature-sensitive magnetic member 64 having low magnetic potentials toward the magnetic core 84. Therefore, the lines of magnetic force H intersecting the conductive heating layer 612 of the fixing belt 61 in the thickness direction are concentratedly radiated from the temperature-sensitive magnetic member 64 toward the magnetic core 84, increasing the magnetic flux density in the region R3.

In the conductive heating layer 612 of the fixing belt 61 in which the lines of magnetic force H intersect in the thickness direction, an eddy current I occurs in proportion to the amount of change in the number of lines of magnetic force H per unit area (magnetic flux density). Therefore, as illustrated in FIG. 6, a large eddy current I occurs in each of the regions R1 and R2 and the region R3 where the amount of change in the magnetic flux density is large. The eddy current I occurring in the conductive heating layer 612 generates Joule heat W (W=I²R), which is the product of the resistivity R of the conductive heating layer 612 and the square of the eddy current I. Hence, in each of the regions of the conductive heating layer 612 where a large eddy current I occurs, high Joule heat W is generated.

Thus, when the fixing belt 61 is at or below the temperature at which magnetic permeability starts to change, high heat is generated in the regions R1 and R2 and the region R3 where the lines of magnetic force H intersect the conductive heating layer 612. Consequently, the fixing belt 61 is heated.

In the fixing unit 60 according to the exemplary embodiment, the temperature-sensitive magnetic member 64 is provided close to the fixing belt 61 on the inner peripheral side of the fixing belt 61. Thus, a configuration is realized in which the magnetic core 84 that induces thereinto the lines of magnetic force H produced by the exciting coil 82 and the temperature-sensitive magnetic member 64 that induces thereinto the lines of magnetic force H intersecting the fixing belt 61 in the thickness direction are provided close to each other. Accordingly, the alternating-current magnetic field produced by the IH heater 80 (exciting coil 82) forms a magnetic circuit in the form of a short loop. Such a magnetic circuit has a high magnetic flux density and a high degree of magnetic coupling. Therefore, when the fixing belt 61 is at or below the temperature at which magnetic permeability starts to change, the fixing belt 61 generates heat very efficiently.

### Movement Mechanism

Referring now to FIGS. 2 and 3, the movement mechanism 200 will be described.

An elastic layer 622 and other elements included in the pressure applying roller 62, details of which will be described separately below, are made of relatively soft materials. Therefore, if the pressure applying roller 62 is kept being pressed against the pressure receiving pad 63 with the fixing belt 61 interposed therebetween while the fixing operation is not being performed, the pressure applying roller 62 may not be able to restore its original shape. That is, the pressure applying roller 62 may be deformed into a shape defined at the nip part N (press-fixing part). In such a case, the pressure applied at the nip part N may deviate from the design value and the fixing operation may not be performed as specified, resulting in deterioration in the performance of the fixing unit 60.

Therefore, the movement mechanism 200 as a pressure-applying-member-moving unit is provided to the pressure applying roller 62 so as to move the pressure applying roller 62 away from the fixing belt 61 when the fixing operation is not performed. Specifically, when the fixing operation is performed, the pressure applying roller 62 is pressed against the outer peripheral surface of the fixing belt 61 so that the pressure applying roller 62 and the fixing belt 61 form the nip part N therebetween through which paper P having an unfixed image is transported. When the fixing operation is not performed, the pressure applying roller 62 is moved away from the fixing belt 61. That is, in the exemplary embodiment, the pressure applying roller 62 is changeable by the movement mechanism 200 between being pressed against the outer peripheral surface of the fixing belt 61 and being spaced apart from the fixing belt 61.

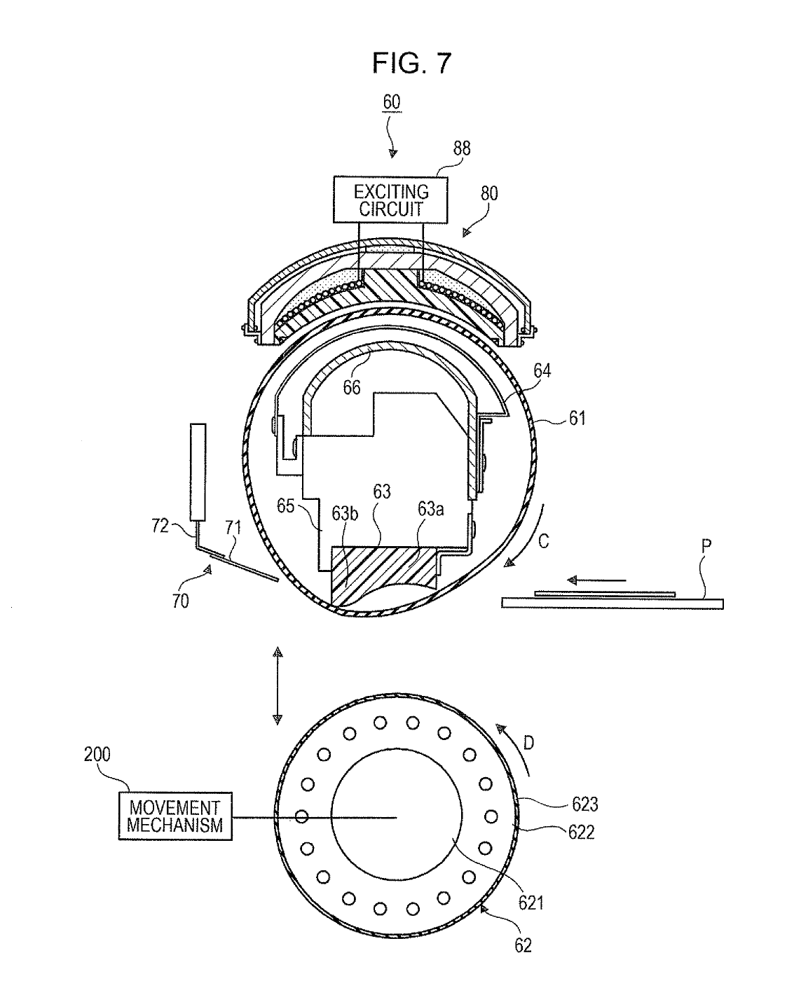

FIG. 7 illustrates the pressure applying roller 62 having been moved away from the fixing belt 61 by the movement mechanism 200.

In FIG. 7, the pressure applying roller 62 is spaced apart from the fixing belt 61. Therefore, the pressure applying roller 62 has its original circular shape. Thus, the probability that the pressure applying roller 62 that has been deformed may not be able to restore its original shape is reduced.

When the fixing operation is performed, the pressure applying roller 62 is brought into contact with the fixing belt 61 again by the movement mechanism 200, whereby the pressure applying roller 62 returns to such a position that the nip part N illustrated in FIG. 3 is formed.

### Drive Mechanism for Pressure Applying Roller and Fixing Belt

Referring to FIGS. 2, 3, and 7, a drive mechanism provided for the pressure applying roller 62 and the fixing belt 61 of the fixing unit 60 according to the exemplary embodiment will now be described.

Here, suppose that the fixing unit 60 is in the state before the fixing operation as illustrated in FIG. 7 where the pressure applying roller 62 is spaced apart from the fixing belt 61. In such a standby state before the fixing operation, the pressure applying roller 62 is retained at a warm-up position away from the fixing belt 61 by the movement mechanism 200. The warm-up position refers to the position of the pressure applying roller 62 during the warm-up time. In this state, the pressure applying roller 62 is latched off, that is, the pressure applying roller 62 is not in physical contact with the fixing belt 61.

Referring to FIG. 2, in the fixing unit 60, a rotational driving force is transmitted from a drive motor 90 as an exemplary drive unit to a shaft 97 through a transmission gear 92 fixed to a rotating shaft 91 and through transmission gears 93, 94, 95, and 96. Thus, the rotational driving force is transmitted to the pressure applying roller 62, and the pressure applying roller 62 rotates in the direction of arrow D.

The rotational driving force from the drive motor 90 is also transmitted to a shaft 103 through a transmission gear 101 fixed to the rotating shaft 91 coaxially with the transmission gear 92 and through a one-way clutch 102 as an exemplary rotation-transmission-regulating member. The rotational driving force is further transmitted to gear portions 67b of end cap members 67 provided at two respective ends of the fixing belt 61 through respective transmission gears 104 and 105 provided on the shaft 103. Thus, the rotational driving force is transmitted from the end cap members 67 to the fixing belt 61, and the end cap members 67 and the fixing belt 61 rotate together. In this operation, the fixing belt 61 directly receives the driving force at the two ends thereof and thus rotates in the direction of arrow C.

In the state illustrated in FIG. 3 where the fixing operation is performed, the fixing unit 60 is latched on, with the pressure applying roller 62 being pressed against the fixing belt 61 by the movement mechanism 200. The speed reduction ratio of the train of gears in the latched-off state is set to such a value that the surface speed of the fixing belt 61 becomes slower than the surface speed of the pressure applying roller 62. Therefore, in the latched-on state, the one-way clutch 102 operates such that the fixing belt 61 rotates by following the rotation of the pressure applying roller 62, and the transmission of the rotational driving force from the drive motor 90 to the shaft 103 is stopped. That is, in the state illustrated in FIG. 3, the rotational driving force is transmitted to the pressure applying roller 62 but is not transmitted to the fixing belt 61. Hence, while the pressure applying roller 62 receiving the rotational driving force from the drive motor 90 rotates in the direction of arrow D, the fixing belt 61 rotates in the direction of arrow C by following the rotation of the pressure applying roller 62. In this state, the drive motor 90 rotates the fixing belt 61 by rotating the pressure applying roller 62.

The fixing unit 60 according to the exemplary embodiment includes a revolution counter 107 that detects the number of revolutions of the fixing belt 61. The number of revolutions of the fixing belt 61 detected by the revolution counter 107 is output to a fixing unit controller 300. The fixing unit controller 300 controls the drive motor 90. Specifically, the fixing unit controller 300 controls the drive motor 90 in a feedback manner on the basis of the number of revolutions of the fixing belt 61 detected by the revolution counter 107. The fixing unit controller 300 also controls the movement mechanism 200. By causing the movement mechanism 200 to move the pressure applying roller 62, the fixing unit controller 300 changes the state of the pressure applying roller 62 between being pressed against the fixing belt 61 and being spaced apart from the fixing belt 61.

The movement mechanism 200 includes a latch motor 201 as a positioning drive source, a rotating shaft 202 connected to the latch motor 201, transmission gears 203 and 204, a shaft 205 connected to the transmission gear 204, eccentric cams 206 rotating with the shaft 205, and levers 207 connected to the shaft 97 of the pressure applying roller 62 and moved by the respective eccentric cams 206. When the eccentric cams 206 rotate, the levers 207 are pushed by the respective eccentric cams 206 and cause the pressure applying roller 62 to move in the vertical direction in FIG. 2. Thus, the pressure applying roller 62 is movable to and away from the fixing belt 61.

### Pressure Applying Roller

The pressure applying roller 62 faces the fixing belt 61 and rotates in the direction of arrow D illustrated in FIG. 3 at a process speed of, for example, 140 mm/s. The nip part N is formed when the fixing belt 61 is nipped between the pressure applying roller 62 and the pressure receiving pad 63. When paper P having unfixed toner images is transported through the nip part N, heat and pressure are applied to the toner images, whereby the unfixed toner images are fixed on the paper P.

The pressure applying roller 62 includes a solid aluminum core (round-columnar metal core) 621 as an exemplary core portion provided at the center of rotation and having an exemplary diameter of 18 mm, an elastic layer 622 provided over the outer periphery of the core 621, a shape retaining layer 623 provided over the outer periphery of the elastic layer 622 and retaining the shape of the pressure applying roller 62, and a release layer 624 forming the surface of the pressure applying roller 62 and facilitating releasing of the paper P from the pressure applying roller 62. The release layer 624 may be provided as a heat-resistive resin coating composed of carbon-filled PFA or the like or a heat-resistive rubber coating with an exemplary thickness of 50 μm. The pressure applying roller 62 presses the pressure receiving pad 63 with an exemplary load of 20 kgf with the fixing belt 61 interposed therebetween.

When the pressure applying roller 62 is pressed against the fixing belt 61, the pressure applying roller 62 elastically deforms, whereby the nip part N is formed. Among the layers included in the pressure applying roller 62, the elastic layer 622 basically deforms when the nip part N is formed. In related-art techniques, the elastic layer is made of heat-resistive rubber or the like such as silicone rubber.

After repetitions of the fixing operation, heat generated by the fixing belt 61 tends to be transferred to the pressure applying roller 62 and to raise the temperature of the pressure applying roller 62. In such a case, if the elastic layer 622 is made of heat-resistive rubber or the like, the elastic layer 622 expands and the outside diameter of the pressure applying roller 62 increases. Nevertheless, when the fixing operation is performed on paper P of a small size, the temperature of the pressure applying roller 62 does not tend to rise in a portion where the paper P passes (hereinafter also referred to as the paper pathway) because heat is taken away for fixing of toner images, whereas the temperature of the pressure applying roller 62 tends to rise in a portion where the paper P does not pass (hereinafter also referred to as the wayside) because heat is not taken away. More specifically, in the pressure applying roller 62, the temperature tends to rise more easily near the ends than in a central portion because the paper P passes over the central portion of the pressure applying roller 62. Consequently, the outside diameter of the pressure applying roller 62 tends to become larger near the ends of the pressure applying roller 62 than in the central portion of the pressure applying roller 62. Practically, the difference in the outside diameter of the pressure applying roller 62 between the paper pathway and each wayside produces a step in the pressure applying roller 62. If any steps are produced in the pressure applying roller 62, the paper P may be wrinkled or deformed during the fixing operation.

To address such a problem, in a related-art technique, a heat pipe roller that rotates while being in contact with the pressure applying roller or a device that cools the surface of the pressure applying roller, for example, is provided so as to make the temperature of the pressure applying roller uniform. In another related-art technique, after the fixing operation is performed on paper P of a small size as described above, the fixing operation is suspended until the pressure applying roller is uniformly cooled to a certain level. Such related-art techniques, however, lead to problems. For example, in the former related-art technique, the cost of manufacturing the fixing unit tends to increase. In the latter related-art technique, convenience for the user of the image forming apparatus is reduced.

Hence, in the exemplary embodiment, the probability that any steps may be produced in the pressure applying roller 62 is reduced by a technique described below.

The elastic layer 622 according to the exemplary embodiment is made of a compressible elastic material. Thus, even if there is any difference in temperature among the portions of the pressure applying roller 62 as described above, when the pressure applying roller 62 is pressed against the fixing belt 61, the pressure applying roller 62 contracts in the portions thereof where the temperature tends to become relatively high. Consequently, the probability that any steps may be produced between the portions where the temperature is relatively high and the portion where the temperature is relatively low is reduced. In contrast, in the related-art techniques, heat-resistive rubber such as silicone rubber used as the elastic layer is incompressible. Therefore, the elastic layer does not tend to contract in such a manner as to eliminate the steps.

In the exemplary embodiment, the Poisson's ratio r of the compressible elastic material used as the elastic layer 622 is, for example, 0.2 or smaller. The Poisson's ratio of the incompressible material such as silicone rubber is about 0.5. The elastic layer 622 has an Asker C hardness of, for example, 10° to 70°.

The material used as the elastic layer 622 may have heat resistivity in addition to the above characteristics. That is, the elastic layer 622 according to the exemplary embodiment may be made of an elastic material having both compressibility and heat resistivity. More specifically, the elastic layer 622 may be made of foamed rubber, in particular, foamed silicone rubber or the like.

In the exemplary embodiment, the shape retaining layer 623 is interposed between the elastic layer 622 and the release layer 624. The shape retaining layer 623 retains the shape of the pressure applying roller 62. With the shape retaining layer 623, deformation of the pressure applying roller 62 is further suppressed.

Thus, in the exemplary embodiment, the elastic layer 622 is made of a compressible elastic material, and the shape retaining layer 623 is provided over the outer periphery of the elastic layer 622. Therefore, even if the temperature of the pressure applying roller 62 rises, the probability that the pressure applying roller 62 may have steps is further reduced. Moreover, the increase in the outside diameter of the pressure applying roller 62 is reduced. Accordingly, the change in the linear speed of the fixing belt 61 is reduced, the change in the speed of transport of the paper P during the fixing operation is reduced, and the change in the length of the nip part N in the direction of transport of the paper P is reduced. Consequently, a stable fixing operation is realized more easily.

The shape retaining layer 623 functions as a base layer for the release layer 624. That is, with the shape retaining layer 623 as a base layer for the release layer 624, the release layer 624 is prevented from being excessively deformed. Thus, abrasion and contamination of the release layer 624 are suppressed, lengthening the service life of the pressure applying roller 62.

The shape retaining layer 623 may be thin so as not to affect the formation of the nip part N. More specifically, the shape retaining layer 623 has a thickness of, for example, 0.5 mm or smaller, or preferably 0.2 mm or smaller. In addition to such thinness, the shape retaining layer 623 may have flexibility and a required level of rigidity. As with the elastic layer 622, the shape retaining layer 623 may also be heat resistive. Exemplary materials for the shape retaining layer 623 that satisfy the above conditions include plastic films (resin films) composed of polyimide, polyimide-amide, polyamide, and the like, and thin metal films composed of stainless steel, nickel, and the like.

The elastic layer 622 and the shape retaining layer 623 may have a relationship with each other that satisfies Expressions (2) and (3) below:

E₁<E₂ (2)

(E₂×T₂)/(E₁×D)≧15 (3)

where E₁ denotes the Young's modulus of the elastic layer 622, E₂ denotes the Young's modulus of the shape retaining layer 623, T₂ denotes the thickness of the shape retaining layer 623, and D denotes the outside diameter of the pressure applying roller 62.

Expression (2) expresses that the shape retaining layer 623 may have a larger Young's modulus than the elastic layer 622. That is, the shape retaining layer 623 may be less deformable than the elastic layer 622. In such a configuration, the shape retaining layer 623 suppresses the expansion of the elastic layer 622. Thus, the shape retaining layer 623 exerts its function well.

In Expression (3), the value “15” on the right hand side means that the amount of expansion of the elastic layer 622 may be reduced to 1/15 by providing the shape retaining layer 623. This value may not necessarily be exact and may be approximate. Experience shows that wrinkling and deformation of the paper P are suppressed when Expression (3) is satisfied.

The pressure applying roller 62 according to the exemplary embodiment may have a larger outside diameter in the axial end portions thereof than in the axially central portion thereof. In the exemplary embodiment, for example, the pressure applying roller 62 gradually thickens toward the axial-direction ends thereof. With the pressure applying roller 62 having such a shape, wrinkling and deformation of the paper P are further suppressed. In the exemplary embodiment, the shape of the pressure applying roller 62 is retained well. Therefore, the effect produced by the gradually thickening shape of the pressure applying roller 62 is exerted well.

In the exemplary embodiment, when the fixing operation is performed, the pressure applying roller 62 may rotate as the driver with the fixing belt 61 following the rotation of the pressure applying roller 62. If any steps are produced in the pressure applying roller 62 in a case where the pressure applying roller 62 functions as the driver, the paper P tends to be wrinkled or deformed more easily. By employing the pressure applying roller 62 according to the exemplary embodiment, however, the effect of suppressing wrinkling and deformation of the paper P is exerted well.

Although the above exemplary embodiment concerns a configuration in which the fixing member is the fixing belt 61 and the pressure applying member is the pressure applying roller 62, the present invention is not limited thereto. For example, the present invention is also applicable to a fixing unit that includes a fixing roller as the fixing member and performs a fixing operation with a pair of the fixing roller and a pressure applying roller. In such a case, the elastic layer and the shape retaining layer according to the exemplary embodiment may be applied to at least one of the two rollers.

### EXAMPLES

The exemplary embodiment of the present invention will be described in more detail by taking some examples. The present invention is not limited to the following examples unless departing from the scope thereof.

### Testing Method

### Examples A1 to A6, B1 to B6, and C1 to C6

A test is conducted in which an image forming operation is performed by the image forming apparatus 1, illustrated in FIG. 1, including the fixing unit 60 described above with reference to FIGS. 2 to 7.

The pressure applying roller 62 of the fixing unit 60 includes the core 621, the elastic layer 622, the shape retaining layer 623, and the release layer 624 as illustrated in FIG. 3. In the test, the outside diameter D of the pressure applying roller 62, the Young's modulus E₁ of the elastic layer 622, and the material, Young's modulus E₂, and thickness T₂ of the shape retaining layer 623 are changed as summarized in Table 1. In the column of Table 1 indicating the material of the elastic layer 622, PFA denotes tetrafluoroethylene-perfluoroalkyl vinyl ether copolymer, PI denotes polyimide, and SUS denotes stainless steel. The elastic layer 622 used in the test is made of foamed silicone rubber, which is a compressible elastic material.

When the outside diameter of the pressure applying roller 62 is set to 3.00E-02 m (30 φ), the thickness of the elastic layer 622 is set to 6 mm. Then, an image forming operation is performed under the following conditions: the fixing belt 61 is at 160° C., the pressure applying roller 62 is at 80° C. on the paper pathway and at 120° C. on the waysides, and the image forming speed is 40 pages per minute (ppm). In this case, the length of the nip part N in the direction of transport of the paper P is 7 mm.

When the outside diameter of the pressure applying roller 62 is set to 5.00E-02 m (50 φ), the thickness of the elastic layer 622 is set to 8 mm. Then, an image forming operation is performed under the following conditions: the fixing belt 61 is at 170° C., the pressure applying roller 62 is at 85° C. on the paper pathway and at 130° C. on the waysides, and the image forming speed is 60 ppm. In this case, the length of the nip part N in the direction of transport of the paper P is 10 mm.

When the outside diameter of the pressure applying roller 62 is set to 1.00E-01 m (100 φ), the thickness of the elastic layer 622 is set to 10 mm. Then, an image forming operation is performed under the following conditions: the fixing belt 61 is at 175° C., the pressure applying roller 62 is at 90° C. on the paper pathway and at 140° C. on the waysides, and the image forming speed is 100 ppm. In this case, the length of the nip part N in the direction of transport of the paper P is 15 mm.

### Comparative Examples A-1, B-1, and C-1

An image forming operation is performed for each of Comparative Examples A-1, B-1, and C-1 under the conditions summarized in Table 1 with the same pressure applying roller 62 as that used in corresponding ones of Examples A1 to A6, B1 to B6, and C1 to C6, except that the shape retaining layer 623 is omitted.

TABLE 1

| | Pressure | | | | | | | | | |
|---|---|---|---|---|---|---|---|---|---|---|
| | applying | | | | | | | | | |
| | roller | | | | | | Change in radius | | | |
| | Outside | Elastic layer | Shape retaining layer | | | | | Paper | | |
| | diameter | Young's | | Young's | Thickness | (E₂ × T₂)/ | Wayside | pathway | Step | Paper |
| | D (m) | modulus E₁ (Pa) | Material | modulus E₂ (Pa) | T₂ (m) | (E₁ × D) | (μm) | (μm) | (μm) | wrinkles |
| Example A1 | 3.00E−02 | 1.68E+0.5 | PFA | 1.32E+08 | 3.00E−05 | 0.79 | 180 | 83.4 | 96.6 | OK |
| Example A2 | 3.00E−02 | 1.68E+0.5 | PFA | 1.32E+08 | 1.00E−04 | 2.62 | 101 | 42 | 59 | OK |
| Example A3 | 3.00E−02 | 1.68E+0.5 | PI | 3.40E+09 | 2.50E−05 | 6.87 | 40 | 26.5 | 13.5 | Good |
| Example A4 | 3.00E−02 | 1.68E+0.5 | PI | 3.40E+09 | 1.00E−04 | 67.46 | 29 | 17.5 | 11.5 | Good |
| Example A5 | 3.00E−02 | 1.68E+0.5 | PI | 3.40E+09 | 1.50E−04 | 101.19 | 27 | 16.3 | 10.7 | Good |
| Example A6 | 3.00E−02 | 1.68E+0.5 | SUS | 1.93E+10 | 3.00E−05 | 114.88 | 28 | 17 | 11 | Good |
| Comparative | 3.00E−02 | 1.68E+0.5 | None | — | 0 | — | 298 | 193 | 105 | No |
| Example A-1 | | | | | | | | | | good |
| Example B1 | 5.00E−02 | 1.68E+0.5 | PFA | 1.11E+08 | 3.00E−05 | 0.40 | 348 | 182 | 166 | OK |
| Example B2 | 5.00E−02 | 1.68E+0.5 | PFA | 1.11E+08 | 1.00E−04 | 1.32 | 238 | 106 | 132 | OK |
| Example B3 | 5.00E−02 | 1.68E+0.5 | PI | 3.40E+09 | 2.50E−05 | 10.12 | 94 | 59 | 35 | OK |
| Example B4 | 5.00E−02 | 1.68E+0.5 | PI | 3.40E+09 | 1.00E−04 | 40.48 | 57 | 35 | 22 | Good |
| Example B5 | 5.00E−02 | 1.68E+0.5 | PI | 3.40E+09 | 1.50E−04 | 60.71 | 53 | 32 | 21 | Good |
| Example B6 | 5.00E−02 | 1.68E+0.5 | SUS | 1.93E+10 | 3.00E−05 | 68.93 | 55 | 33 | 22 | Good |
| Comparative | 5.00E−02 | 1.68E+0.5 | None | — | 0 | — | 452 | 286 | 166 | No |
| Example B-1 | | | | | | | | | | good |
| Example C1 | 1.00E−01 | 1.68E+0.5 | PFA | 9.35E+07 | 3.00E−05 | 0.17 | 614 | 357 | 257 | OK |
| Example C2 | 1.00E−01 | 1.68E+0.5 | PFA | 9.35E+07 | 1.00E−04 | 0.56 | 526 | 278 | 248 | OK |
| Example C3 | 1.00E−01 | 1.68E+0.5 | PI | 3.40E+09 | 2.50E−05 | 5.06 | 268 | 168 | 100 | OK |
| Example C4 | 1.00E−01 | 1.68E+0.5 | PI | 3.40E+09 | 1.00E−04 | 20.24 | 153 | 92 | 61 | Good |
| Example C5 | 1.00E−01 | 1.68E+0.5 | PI | 3.40E+09 | 1.50E−04 | 30.36 | 134 | 80 | 54 | Good |
| Example C6 | 1.00E−01 | 1.68E+0.5 | SUS | 1.93E+10 | 3.00E−05 | 34.46 | 137 | 81 | 56 | Good |
| Comparative | 1.00E−01 | 1.68E+0.5 | None | — | 0 | — | 652 | 412 | 240 | No |
| Example C-1 | | | | | | | | | | good |

### Evaluation Method

After performing the image forming operation for each of Examples A1 to A6, B1 to B6, and C1 to C6 and Comparative Examples A-1, B-1, and C-1, the results are evaluated in three ranks of good, OK, and no good. Good indicates that the paper P has no wrinkles, OK indicates that the paper P has some wrinkles that do not substantially trigger problems, and no good indicates that the paper P has wrinkles that are not allowable. Furthermore, the radius of the pressure applying roller 62 is measured in the portion (paper pathway) where the paper P passes and in the portions (waysides) where the paper P does not pass, whereby the heights of any steps produced in the pressure applying roller 62 are calculated.

### Results of Evaluation

The results of the evaluation are also summarized in Table 1.

As summarized in Table 1, Examples A1 to A6, B1 to B6, and C1 to C6 in each of which the pressure applying roller 62 includes the elastic layer 622 made of foamed silicone rubber, which is a compressible elastic material, and the shape retaining layer 623 are rated good or OK in terms of paper wrinkles. In contrast, Comparative Examples A-1, B-1, and C-1 in each of which the pressure applying roller 62 does not include the shape retaining layer 623 are rated no good in terms of paper wrinkles. Among Examples A1 to A6, B1 to B6, and C1 to C6, Examples A3 to A6, B4 to B6, and C4 to C6 that satisfy Expressions (2) and (3) are rated better in terms of paper wrinkles than Examples A1 and A2, B1 to B3, and C1 to C3 that do not satisfy Expressions (2) and (3).

There is a correlation between the result of the evaluation of paper wrinkles and the heights of the steps produced in the pressure applying roller 62. Specifically, the smaller the steps in the pressure applying roller 62, the better the result of the evaluation of paper wrinkles.

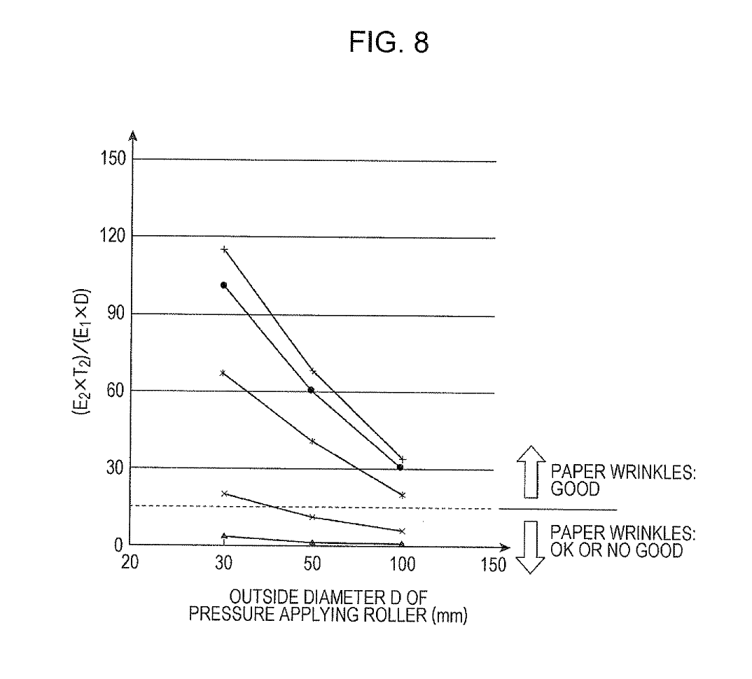

FIG. 8 illustrates the relationship between the outside diameter D of the pressure applying roller 62 and Expression (3) given above. In FIG. 8, the horizontal axis represents the outside diameter D of the pressure applying roller 62, and the vertical axis represents the value calculated in accordance with the left hand side of Expression (3).

FIG. 8 is a graph plotted on the basis of the results of Examples A2 to A6, B2 to B6, and C2 to C6 summarized in Table 1. As illustrated in FIG. 8, when the value on the left hand side of Expression (3) is 15 or greater, the result of the evaluation of paper wrinkles is rated good; when the value on the left hand side of Expression (3) is below 15, the result of the evaluation of paper wrinkles is rated OK or no good.

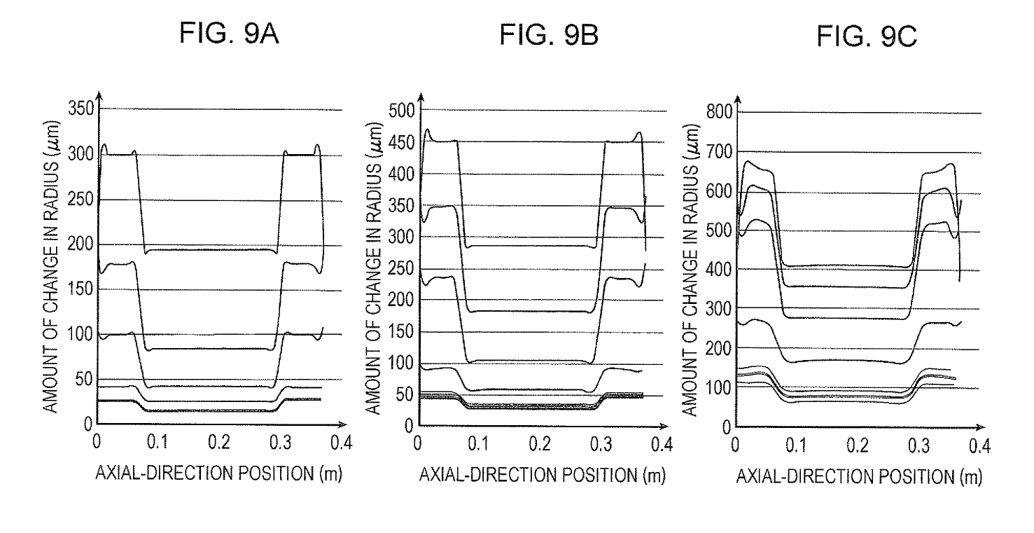

FIGS. 9A to 9C each illustrate the relationship between the axial-direction position of the pressure applying roller 62 and the amount of change in the radius of the pressure applying roller 62. In each of FIGS. 9A to 9C, the horizontal axis represents the axial-direction position of the pressure applying roller 62, and the vertical axis represents the amount of change in the radius of the pressure applying roller 62 with respect to the axial-direction position of the pressure applying roller 62.

FIG. 9A illustrates the case where the outside diameter of the pressure applying roller 62 is 30 φ. FIG. 9B illustrates the case where the outside diameter of the pressure applying roller 62 is 50 φ. FIG. 9C illustrates the case where the outside diameter of the pressure applying roller 62 is 100 φ. The curves illustrated in FIG. 9A represent, in order from the top, Comparative Example A-1, Example A1, Example A2, Example A3, Example A4, Example A5, and Example A6, respectively. The curves illustrated in FIG. 9B represent, in order from the top, Comparative Example B-1, Example B1, Example B2, Example B3, Example B4, Example 85, and Example B6, respectively. The curves illustrated in FIG. 9C represent, in order from the top, Comparative Example C-1, Example C1, Example C2, Example C3, Example C4, Example C5, and Example C6, respectively.

As can be seen from FIGS. 9A to 9C, steps are produced in the pressure applying roller 62 at axial-direction positions of about 0.1 m and about 0.3 m. It is also obvious that the steps produced in the pressure applying roller 62 are smaller in Examples A1 to A6, B1 to B6, and C1 to C6 than in Comparative Examples A-1, B-1, and C-1, respectively.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing device comprising:
a rotatable fixing member that fixes a toner image on a recording material; and
a rotatable pressure applying member that is pressed against an outer peripheral surface of the fixing member and forms a press-fixing part therebetween through which the recording material having an unfixed toner image is transported;
wherein at least one of the fixing member and the pressure applying member includes
a core portion provided at a center of rotation;
a compressible elastic layer provided over an outer periphery of the core portion; and
a shape retaining layer provided over an outer periphery of the elastic layer and retaining a shape of the at least one of the fixing member and the pressure applying member.

2. The fixing device according to claim 1 satisfying the following expressions:
E₁<E₂
(E₂×T₂)(E₁×D)≧15
where E₁ denotes the Young's modulus of the elastic layer, E₂ denotes the Young's modulus of the shape retaining layer, T₂ denotes the thickness of the shape retaining layer, and D denotes the outside diameter of the at least one of the fixing member and the pressure applying member.

3. The fixing member according to claim 1 further comprising a release layer that forms a surface of at least one of the fixing member and the pressure applying member and facilitates releasing of the recording material from the at least one of the fixing member and the pressure applying member.

4. The fixing member according to claim 2 further comprising a release layer that forms a surface of at least one of the fixing member and the pressure applying member and facilitates releasing of the recording material from the at least one of the fixing member and the pressure applying member.

5. The fixing device according to claim 1, wherein the at least one of the fixing member and the pressure applying member including the elastic layer and the shape retaining layer has a larger outside diameter in axial end portions thereof than in an axially central portion thereof.

6. The fixing device according to claim 2, wherein the at least one of the fixing member and the pressure applying member including the elastic layer and the shape retaining layer has a larger outside diameter in axial end portions thereof than in an axially central portion thereof.

7. The fixing device according to claim 3, wherein the at least one of the fixing member and the pressure applying member including the elastic layer and the shape retaining layer has a larger outside diameter in axial end portions thereof than in an axially central portion thereof.

8. The fixing device according to claim 4, wherein the at least one of the fixing member and the pressure applying member including the elastic layer and the shape retaining layer has a larger outside diameter in axial end portions thereof than in an axially central portion thereof.

9. The fixing device according to claim 1 further comprising a drive source that rotates the fixing member by rotating the pressure applying member.

10. The fixing device according to claim 2 further comprising a drive source that rotates the fixing member by rotating the pressure applying member.

11. The fixing device according to claim 3 further comprising a drive source that rotates the fixing member by rotating the pressure applying member.

12. The fixing device according to claim 4 further comprising a drive source that rotates the fixing member by rotating the pressure applying member.

13. The fixing device according to claim 5 further comprising a drive source that rotates the fixing member by rotating the pressure applying member.

14. The fixing device according to claim 6 further comprising a drive source that rotates the fixing member by rotating the pressure applying member.

15. The fixing device according to claim 7 further comprising a drive source that rotates the fixing member by rotating the pressure applying member.

16. The fixing device according to claim 8 further comprising a drive source that rotates the fixing member by rotating the pressure applying member.

17. An image forming apparatus comprising:
a toner-image-forming section that forms a toner image;
a transfer section that transfers the toner image to a recording material; and
a fixing section that includes
a rotatable fixing member that fixes the toner image on the recording material, and
a rotatable pressure applying member that is pressed against an outer peripheral surface of the fixing member and forms a press-fixing part therebetween through which the recording material having an unfixed toner image is transported,
wherein at least one of the fixing member and the pressure applying member includes
a core portion provided at a center of rotation;
a compressible elastic layer provided over an outer periphery of the core portion; and
a shape retaining layer provided over an outer periphery of the elastic layer and retaining a shape of the at least one of the fixing member and the pressure applying member.

18. The image forming apparatus according to claim 17 satisfying the following expressions:
E₁<E₂
(E₂×T₂)/(E₁×D)≧15
where E₁ denotes the Young's modulus of the elastic layer, E₂ denotes the Young's modulus of the shape retaining layer, T₂ denotes the thickness of the shape retaining layer, and denotes the outside diameter of the at least one of the fixing member and the pressure applying member.
